(19) United States
(12) Patent Application Publication
(10) Pub. No.: US 2010/0112297 A1
(43) Pub. Date: May 6, 2010

(54) HOUSING AND METHOD FOR MAKING THE SAME

(75) Inventors: FENG-YUEN DAI, Shindian (TW); YUNG-TA LO, Shindian (TW); CHWAN-HWA CHIANG, Shindian (TW); JING HAN, Shenzhen City (CN); BAO-SHEN ZHANG, Shenzhen City (CN); QI-QI YAN, Shenzhen City (CN); WEI LIU, Shenzhen City (CN); YONG QIAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/563,232

(22) Filed: Sep. 21, 2009

(30) Foreign Application Priority Data
Oct. 30, 2008 (CN) 200810305310.9

(51) Int. Cl. B32B 3/10; C25D 5/02

(52) U.S. Cl. 428/172; 205/122; 219/121.69

(57) ABSTRACT

A housing, comprising: a substrate; a micro-arc oxide film formed on the substrate; and a plurality of grooves formed on the oxide film; wherein all or part of the oxide film is polished to present a glossy appearance, the grooves are formed on the polished region of the oxide film. A method for making housing, comprising: providing a substrate; micro-arc oxidizing the substrate to form a micro-arc oxide film on the substrate; polishing at least part of the micro-arc oxide film; and etching the polished surface of the micro-arc oxide film to form grooves in the polished surface.

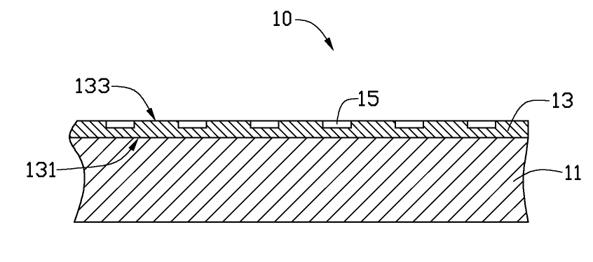

### CROSS-REFERENCE TO RELATED APPLICATIONS

This application is one of the two related co-pending U.S. patent applications listed below. All listed applications have the same assignee. The disclosure of each of the listed applications is incorporated by reference into all the other listed applications.

| Attorney | | |
|---|---|---|
| Docket No. | Title | Inventors |
| US23419 | HOUSING AND METHOD FOR | FENG-YUEN |
| | MAKING THE SAME | DAI et al. |
| US23422 | METHOD FOR MAKING HOUSING | FENG-YUEN |
| | AND HOUSING THEREOF | DAI et al. |

### BACKGROUND

1. Technical Field

The present disclosure relates to housings and method for making the same.

2. Description of Related Art

Micro-arc oxidation is a surface treatment process that oxidizes a metal surface to form a micro-arc oxide film. Micro-arc oxide films have similar appearance and physical properties as ceramics and possess high rigidity. However, the micro-arc oxide film can only present matte appearance and cannot decorate the housing with more attractive gloss.

Therefore, there is room for improvement within the art.

### BRIEF DESCRIPTION OF THE DRAWING

Many aspects of the housing can be better understood with reference to the following drawing. The components in the drawing are not necessarily drawn to scale, the emphasis instead being placed upon clearly illustrating the principles of the housing.

The figure is a cross-sectional view of an exemplary embodiment of a housing.

### DETAILED DESCRIPTION

Referring to the figure, in an exemplary embodiment, a housing 10 includes a substrate 11 and a micro-arc oxide film 13 formed on the substrate 11.

The substrate 11 is made of metal selected from a group consisting of aluminum, aluminum alloy, magnesium, magnesium alloy, titanium and titanium alloy.

The micro-arc oxide film 13 includes a first surface 131 and a second surface 133 on an opposite side to the first surface 131. The first surface 131 is directly bonded with the substrate 11. All or part of the second surface 133 of the oxide film 13 is mechanically polished to present a glossy appearance.

A plurality of grooves 15 are defined in polished regions of the second surface 133. These grooves 15 define a predetermined pattern on the housing 10. The pattern may be a logo or a decorative pattern. The grooves 15 may be formed by laser etching. These grooves 15 have a matte surface like the micro-arc oxide film 13.

A method for making the housing 10 may generally comprise the following steps: providing a substrate; micro-arc oxidizing the substrate to form a micro-arc oxide film on the substrate; polishing at least a portion of the micro-arc oxide film, and etching the polished surface(s) of the oxide film to form grooves. Each step is described in more detail below.

A substrate 11 is provided. The substrate 11 is made of metal selected from a group consisting of aluminum, aluminum alloy, magnesium, magnesium alloy, titanium, and titanium alloy.

The substrate 11 is de-dusted in an alkaline solution. Dust adhering to the substrate 11 is removed by the de-dustings process. After the de-dusting process, the substrate 11 is rinsed in water.

The substrate 11 is micro-arc oxidized in an electrolyte contained in a stainless steel tank to form a micro-arc oxide film 13 on the surface of the substrate 11. The electrolyte includes at least one of phosphate salt, borate salt, silicate salt, aluminate salt, and alkali metal hydroxide. The electrolyte may further include at least one of tungstate salt, vanadate salt, ammonium metavanadate, sulfate salt, sodium fluoride, cobalt acetic, sorbitol, and glycerol. The pH of the electrolyte may be in a range of about 10.5-12.5. The temperature of the electrolyte is about 20-50° C. During the oxidation process, a bidirectional voltage pulse including a forward pulse and a reverse pulse is applied to the substrate 11 and the stainless steel tank for about 30-180 minutes to develop the micro-arc oxide film 13. The pulse width of the bidirectional pulse is about 1000-10000 microseconds (μs). The pulse interval of the bidirectional pulse is about 300-2000 μs. During the forward pulse, the voltage gradually grows to a positive voltage in a range of about 450-650 volts. During the reverse pulse, the voltage gradually grows to a negative voltage in a range of about −30˜−200 volts.

After the micro-arc oxidation process, the substrate 11 having the micro-arc oxide film 13 is rinsed in water and baked in an oven.

All or part of the micro-arc oxide film 13 is mechanically polished to present a glossy appearance. The polishing process may comprise a rough polishing step, a secondary polishing step, and a precise polishing step. The rough polishing step may be carried out by a copper polishing disk for about 4-7 minutes. The secondary polishing step may be carried out by a resin polishing disk for about 1-4 minutes. The precise polishing step may be carried out by a polyurethane polishing disk for about 0.5-1.5 minutes.

The polished surface of the micro-arc oxide film 13 is laser etched to form a plurality of grooves 15. These grooves 15 define a predetermined pattern. The pattern may be a logo or a decorative pattern. These grooves 15 have a matte surface like the oxide film 13.

The micro-arc oxide film 13 undergoes a sealing process to seal the micro pores of the oxide film 13 to prevent the film 13 from being contaminated. The sealing agent used in the sealing process may be a mixture of silicone resin and a diluting agent. The silicone resin may be methyl hydrogen silicone fluid. The diluting agent may be organic solvent selected from a group consisting of isopropyl alcohol, toluene, xylene and acetone. The mass ratio between the silicone resin and the organic solvent is about 1˜2:0.5˜1.5. The sealing process is carried out by uniformly daubing the micro-arc oxide film 13 with the sealing agent to make some of the sealing agent be adsorbed into the micro pores of the oxide film 13. After the sealing process, the film 13 is cleaned by using a dry clean wiper to remove the extra sealing agent on the film 13 that was not adsorbed. After the cleaning process, the film 13 is baked in an oven.

The exemplary method for making the housing 10 etches grooves 15 on the micro-arc oxide film 13 first to give a predetermined pattern having a matte appearance, and then polishes the surface of the film 13 to present, for example, a glossy appearance in strong or subtle contrast to the predetermined pattern, which improves the attraction of the housing 10.

It should be understood, however, that even though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A housing, comprising:
a substrate;
a micro-arc oxide film formed on the substrate; and
a plurality of grooves formed in the oxide film;
wherein all or part surface of the oxide film is polished to present a glossy appearance, the grooves form on the polished region of the oxide film.

2. The housing as claimed in claim 1, wherein the substrate is made of metal selected from a group consisting of aluminum, aluminum alloy, magnesium, magnesium alloy, titanium, and titanium alloy.

3. The housing as claimed in claim 1, wherein the grooves are formed by laser etching.

4. A method for making housing, comprising:
providing a substrate;
micro-arc oxidizing the substrate to form a micro-arc oxide film on the substrate;
polishing at least a portion of the micro-arc oxide film; and
etching a polished surface of the micro-arc oxide film to form grooves in the polished surface.

5. The method as claimed in claim 4, wherein the micro-arc oxidation process is carried out in an electrolyte containing at least one of phosphate salt, borate salt, silicate salt, aluminate salt, and alkali metal hydroxide.

6. The method as claimed in claim 5, wherein the electrolyte contains at least one of tungstate salt, vanadate salt, sulfate salt, sodium fluoride, cobalt acetic, sorbitol, and glycerol.

7. The method as claimed in claim 6, wherein the electrolyte has a pH of about 10.5-12.5.

8. The method as claimed in claim 4, wherein the micro-arc oxidation process employs a bidirectional voltage pulse including a forward pulse having a positive voltage in a range of about 450-650 volts and a reverse pulse having a negative voltage in a range of about −30˜−200 volts; the pulse width of the bidirectional pulse is about 1000-10000 μs, the pulse interval of the bidirectional pulse is about 300-2000 μs.

9. The method as claimed in claim 4, wherein the polishing process includes a rough polishing step, a secondary polishing step, and a precise polishing step.

10. The method as claimed in claim 4, wherein the etching step is carried out by laser.

11. The method as claimed in claim 4, wherein the substrate is made of metal selected from a group consisting of aluminum, aluminum alloy, magnesium, magnesium alloy, titanium, and titanium alloy.

12. The method as claimed in claim 4, wherein the method further includes a de-dusting process for the substrate prior to the micro-arc oxidation process.

13. The method as claimed in claim 4, wherein the method further includes a sealing process for the micro pores of the micro-arc oxide film after the etching process.
